(19) United States
(12) Patent Application Publication
(10) Pub. No.: US 2012/0055909 A1
(43) Pub. Date: Mar. 8, 2012

(54) METHOD OF LASER-WELDING AND METHOD OF MANUFACTURING BATTERY INCLUDING THE SAME

(76) Inventors: Hideaki Miyake, Aichi (JP); Takahiro Oshima, Aichi (JP)

(21) Appl. No.: 13/319,700

(22) PCT Filed: May 15, 2009
(86) PCT No.: PCT/JP2009/002152

§ 371 Date: Nov. 10, 2011

(51) Int. Cl. B23K 26/00

(52) U.S. Cl. 219/121.64

(57) ABSTRACT

Provided is a method of laser-welding that can achieve uniform welding of a member with large laser reflectance on a surface thereof A laser welding step (S1) includes a surface roughening step (S11) in which a first laser processing device irradiates laser light to a surface (each welding portion (31)) of a welding section (30, 30, 30, 30) between a negative electrode terminal (20) (a first member) and a negative electrode lead (21) (a second member) and carries out roughening, thereby forming a laser marker (32) on the surface; and a welding step (S12) in which a second laser processing device irradiates laser light to each welding portion (31) roughened in the surface roughening step (S11) and melts each welding portion (31), thereby carrying out the laser-welding of the negative electrode terminal (20) to the negative electrode lead (21).

### TECHNICAL FIELD

The present invention relates to a method of welding using laser beam and a method of manufacturing a battery including the same, especially to a technique of laser welding a member, such as a copper member, having high laser reflectance on the surface thereof

### BACKGROUND ART

There is a technique of bonding two metal members by using the laser welding, and that is broadly used in the industrial field.

The laser welding using YAG laser beam is easy to be used under air atmosphere, and therefore it is really advantageous in the respect of costs and control, compared to other welding technique, e.g. the electron beam welding (EBW) which is performed under vacuum atmosphere. The laser welding using YAG laser tends to be applied to the mass production line.

When laser welding the member with high laser reflectivity on the surface such as the copper member, most of the laser light reflects on the surface and it is difficult to obtain enough heat input. Now, the laser welding to such member is not put to practical use.

There is a laser machining apparatus using green laser that has good absorption to the copper member. Unfortunately, the laser machining apparatus using the green laser generally has low output, and hence the apparatus is used only for welding or machining of the thin member.

As to the manufacturing process for a battery such as the lithium ion secondary battery, in the light of the efficiency in the assembling process, two copper members are welded (e.g., the lead of the negative electrode and the negative electrode terminal).

However, as mentioned above, if the normal laser machining apparatus is used, the enough heat input will not be obtained because the copper members reflect the laser beam or the laser output is low, and thereby, it is hard to provide enough welding depth.

One of the methods to solve the above problem is to use a laser machining apparatus with high laser output. Unfortunately, spatter and soot may occur or the welding point may be penetrated, whereby there is a problem with the weldability.

Furthermore, the laser machining apparatus with high laser output gives heat input to the surrounding members more than necessary, so that the members disposed around the welding point may cause thermal failure.

JP 2003-263977 A discloses a technique of lowering the laser reflectance on the surface by roughening the surface to be welded in advance by using a sand paper, a grind agent, a blast shot, or a chemical etching.

The roughening method of JP 2003-263977 A is applicable to roughen broadly, but that is hardly applicable to roughen the minute point evenly that has the shape variation such as step surface, so that the variation in the surface condition easily appears. Moreover, the roughening methods need masking during the roughening process or cleaning after roughening, and the process may be complex so that it is troublesome to use in the production line.

Especially in using the high-output laser machining apparatus, it is easy to be influenced on the variation in the surface condition or the product condition (for instance, the shape thereof or the assemble accuracy). So, the heat input during the laser welding becomes unstable and the welding failure easily happens.

Thus, the conventional laser welding method may fail to weld evenly the members of high laser reflectance on the surface.

### CITATION LIST

Patent Literature
PTL 1: JP 2003-263977 A

### SUMMARY OF INVENTION

### Technical Problem

The objective of the present invention is to provide methods of laser welding and of manufacturing a battery enabled to weld evenly a member having high laser reflectance on the surface thereof.

### Technical Solution

The first aspect of the present invention is a method of laser welding a first member and a second member. The method includes a roughening step for roughening a surface of the welding portions of the first and second members using a laser beam applied from a first laser machining apparatus and a welding step for melting the roughened surface using laser beam applied from a second laser machining apparatus and welding the first and second members.

In the first aspect of the present invention, the first and second members are members of high laser reflectance on the surfaces thereof with respect to the laser beam applied from the second laser machining apparatus.

In the preferable embodiment of the first aspect of the present invention, the welding using the second laser machining apparatus is performed under oxygen atmosphere.

The second aspect of the present invention is a method of manufacturing a battery including the first and second members as a configuration, in which the first and second members are bonded using the method according to the first aspect of the present invention.

In the method of manufacturing the battery, it is advantageously applicable to the case where the first and second members include a portion formed by caulking a rivet portion in the welding portion. That is, the second aspect of the present invention is applicable to the member to be welded has high laser reflectance and has the deformed minute portion.

### ADVANTAGEOUS EFFECTS OF INVENTION

According to the embodiment of the present invention, the even welding for the members of high laser reflectance on the surface thereof is achieved.

### BRIEF DESCRIPTION OF DRAWINGS

FIG. 1 schematically illustrates a battery.

FIG. 2 is a section view of welding portions in the battery that is an object to be laser welded.

FIG. 3 is a plain view of the welding portions.

FIG. 4 is a flowchart of a laser welding step.

FIG. 5 depicts the laser welding step.

FIG. 6 is an enlarged view showing the welding portions.

### REFERENCE SIGNS LIST

10: battery
20: negative electrode terminal (first member)
21: negative electrode lead (second member)
22: rivet portion
30: welding portion
31: welding point
32: laser mark

### DESCRIPTION OF EMBODIMENTS

Referring to drawings, a laser welding step S1 as an embodiment of the present invention is described. In the laser welding step S1, a negative electrode terminal 20 and a negative electrode lead 21 composing the negative electrode of a battery 10 is welded by using laser beam.

Hereinafter, the structure of the battery 10 to be welded in the laser welding step S1 is explained.

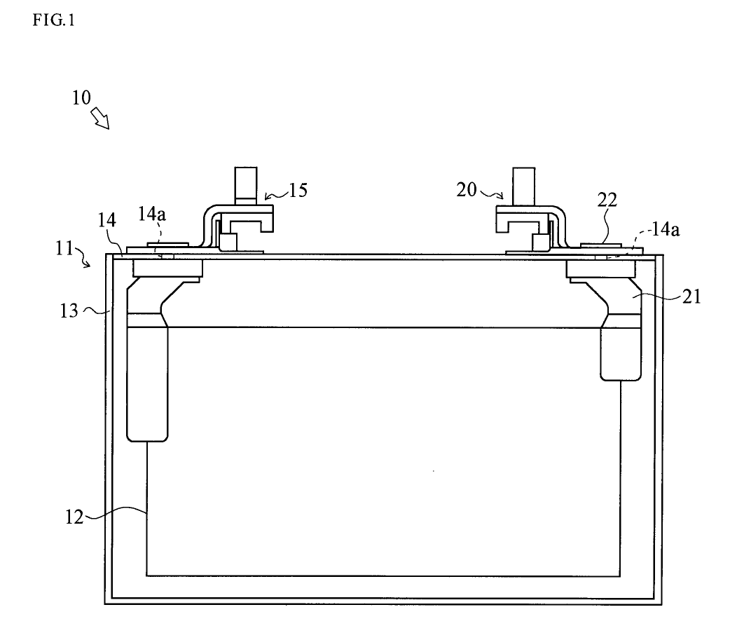

The battery 10 is a lithium ion secondary battery, and as shown in FIG. 1, includes a casing 11 housing an electric power generating element 12. The casing 11 has a box 13 and a lid 14 covering the opening of the box 13. The lid 14 is formed with two holes 14a through which a positive electrode terminal 15 and the negative electrode terminal 20 are projected outward.

The negative electrode terminal 20 is an outer electrode terminal made of copper, and electrically connected to the element 12 via the negative electrode lead 21.

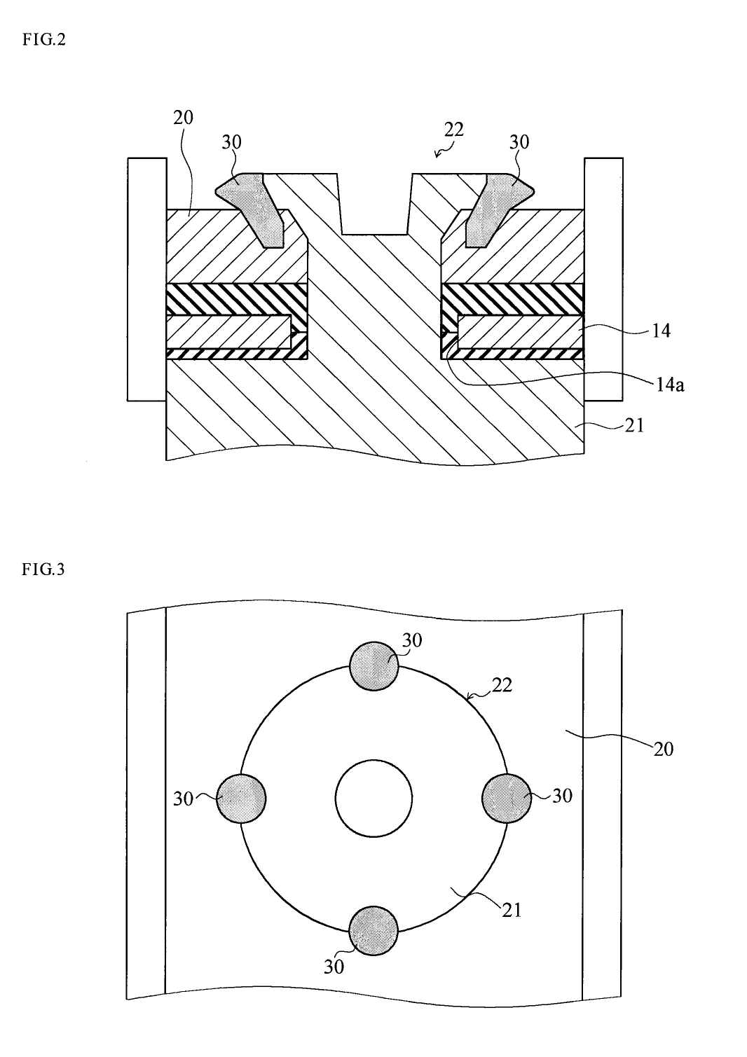

In detail, as depicted in FIGS. 2 and 3, the negative electrode terminal 20 and the negative electrode lead 21 are welded to the hole 14a of the lid 14 where a rivet portion 22 formed at the head of the lead 21 is caulked through a sealing member 23 and an insulating member 24. The terminal 20 and the lead 21 are connected by four welded portions 30.

In the viewpoint of quality control, the welded portions 30 are four in number, but the number thereof may be determined selectively.

The negative electrode lead 21 is a collective electrode terminal made of copper as same as the terminal 20, and connected to the negative electrode side of the element 12.

The rivet portion 22 is formed at the end of the lead 21 having the shape of rivet. The head of the rivet portion 22 has the larger diameter than the inner diameter of the hole 14a of the lid 14. As shown in FIG. 2, in the welded portion 30, the head of the rivet portion 22 is above the top (highest position) of the terminal 20.

The sealing member 23 is made of resin, and is disposed between the lead 21 and the lid 14 to seal the inside of the casing 11.

The insulating member 24 is made of resin, and insulates between the lead 21 and the lid 14, thereby preventing the electric conduction from the lead 21 to the lid 14.

As described above, the laser welding step S1 includes a step for laser welding the negative electrode terminal 20 as a copper member and the rivet portion 22 of the negative electrode lead 21 as a copper member, both of which are contained in the battery 10.

As shown in FIG. 2, the welding portions 30 between the terminal 20 and the rivet portion 22 of the lead 21 are formed in an uneven shape and has a step, and thereby the shape of the welding portion is complex. Further, the head of the rivet portion 22 is caulked, so that the surface of the welding portion is rough. Due to these features, the laser welding requires high accuracy, for example, it requires stable heat input and enough laser penetration.

In the vicinity of the welding portions 30 between the terminal 20 and the lead 21, the resin members are disposed that have weaker heat resistance than the metal members, so that the heat influence on these members around the welding portions 30 should be considered, e.g., the laser output should be lowered.

As described above, the laser welding step S1 provides the laser welding with high accuracy and takes into consideration of the heat influence.

The laser welding step S1 is described below.

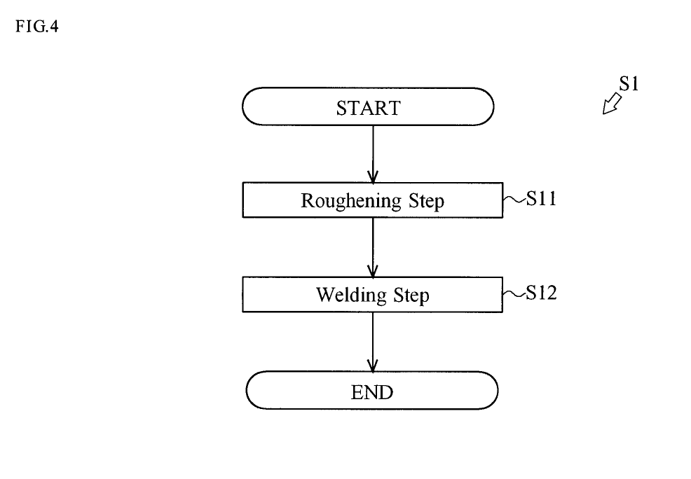

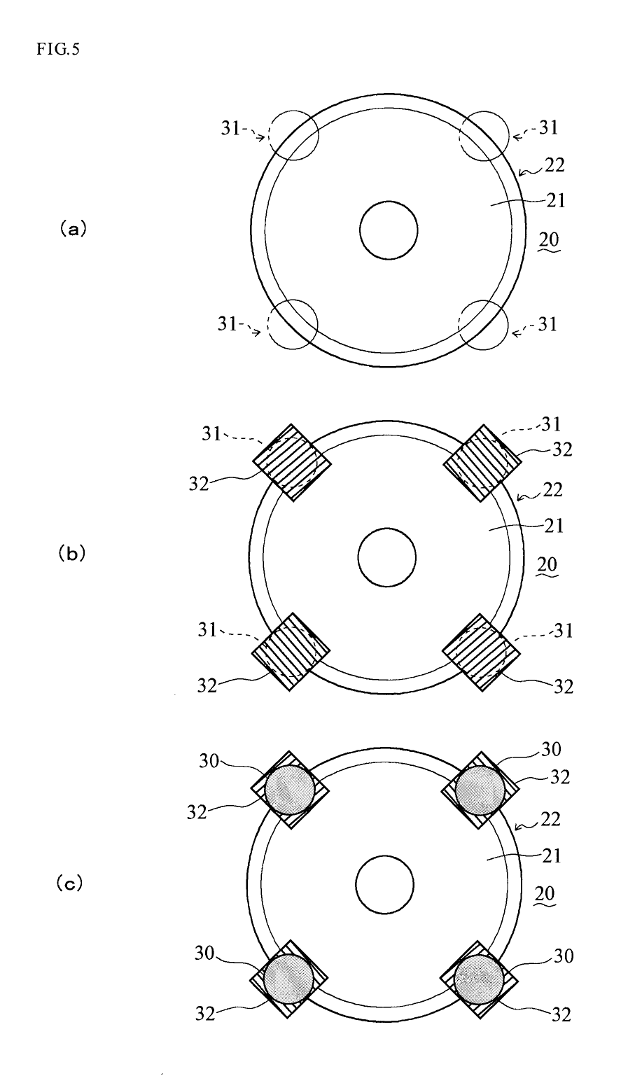

As depicted in FIGS. 4 and 5, the laser welding step S1 includes a roughening step S11 and a welding step S12.

The roughening step S11 includes applying a laser beam to the surface of the portions to be formed as the welding portions 30 using a first laser machining apparatus and roughening the surface where the laser beam is applied. In the roughening S11, the first laser machining apparatus emits a laser beam having a wavelength with good absorption to such members that have high laser reflectance on the surface (the member of high reflectance, such as copper).

The welding step S12 includes applying a laser beam to the surface roughened in the roughening step S11 to be formed as each welding portion 30 using the second laser machining apparatus and melting the portion to which the laser beam is applied for laser welding. The second laser machining apparatus is used for the general laser welding and applies the YAG laser beam.

In the roughening step S11, the green laser beam with 532 nm wavelength is applied to the surface of the portions to be formed as the welding portions 30 (in this embodiment, four welding points 31 shown in FIG. 5(a)) to form laser marks 32 at these points, thereby roughening the welding points 31.

The welding points 31 are set so as to provide the required welding portions 30, and as shown in FIG. 5, the welding points are set in the parts of the periphery of the rivet portion 22 of the lead 21 and the parts of the terminal 20 overlapped by the periphery of the rivet portion 22.

It should be noted that the arrangement of the welding points 31 set in the roughening step S11 is not limited in accordance with the positions or the areas of the welding portions 30. That is, the welding points 31 may be set in any position where the required welding portions 30 are formed.

More specifically, as shown in FIG. 5(b), in the roughening step S11, the first laser machining apparatus applies the green laser beam to the welding points 31 that are set in the outer periphery of the rivet portion 22 caulked in circular shape and in the part of the terminal 20 where the outer periphery of the rivet portion 22 overlaps. Thereby, the laser marks 32 having rectangular shapes are created and the surface where the laser beam is emitted is evenly roughened. The laser marks 32 have grooves with a predetermined depth (e.g., 0.3 μm to 0.4 μm) and are formed as the step surface.

Thus, the surface of the portions where the laser marks 32 are formed are tarnished, so that it is possible to use the second laser machining apparatus using the YAG laser beam that has the high laser reflectance on the surface of the copper member.

When the YAG laser beam is applied to the members of high laser reflectivity such as the copper member without surface processing, the most of the laser beam reflects on the surface and the absorption rate is low, and therefore it is difficult to obtain good weldability. However, due to the laser marks 32 formed on the laser points 31, the surface loses gloss and the YAG laser beam emitted from the second laser machining apparatus is efficiently absorbed in the laser points 31, thereby obtaining good weldability.

In the embodiment, “member of high laser reflectance/reflectivity” means the member as follows: when the YAG laser beam is applied to the surface thereof without surface processing, the most of the laser beam is reflected on the surface and the absorption into the member is low, and therefore it is difficult to obtain good weldability.

The first laser machining apparatus used in the roughening step S11 is controlled with position and timing of laser applying by a controller so that the laser marks 32 have required areas with regard to the welding points 31 (for example, larger than the welding point 31 shown in FIG. 5(b)) and required depths of laser penetration.

As described above, the green laser beam that is controllable with high accuracy provides the laser marks 32 on the welding points 31, and hence the roughening step is easily set in the mass production line such as manufacturing line of the batteries 10.

In the welding step S12, the YAG laser beam with 1064 nm wavelength is applied to the welding points 31 formed with the laser marks 32 to melt the surfaces of the terminal 20 and the rivet portion 22 of the lead 21 so as to weld the terminal 20 and the lead 21, thereby forming the welding portions 30.

More specifically, as shown in FIG. 5(c), in the welding step S12, the second laser machining apparatus applies the YAG laser beam to the laser marks 32 formed in the rivet portion 22 and the terminal 20 to melt the welding points 31 so as to laser weld the terminal 20 and the rivet portion 22.

As described above, the surface of the welding points 31 formed with the laser marks 32 lose the gloss which the copper member originally has and the area of the surface is increased due to the rough surface formed by the laser mark 32. Thus, at the welding points 31, the YAG laser beam emitted from the second laser machining apparatus is efficiently absorbed. Therefore, even in the welding points 31 made by copper, the laser penetration due to the heat input is deepen, so that the sufficient depth of laser penetration and welding areas are obtained.

Moreover, each welding points 31 has the laser mark 32 which roughens the surface evenly, and hence the surface condition is stable and the heat input to the welding points 31 from the laser beam is stable.

According to the laser welding step S1, the negative electrode terminal 20 made of copper having high laser reflectance on the surface thereof (especially high reflectivity with respect to the second laser machining apparatus) and the rivet portion 22 of the negative electrode lead 21 also made of copper are evenly welded at the welding points 31, thereby preventing the welding failures such as blow holes or cracks.

Furthermore, the same effects enhance the robustness against the variation in caulked portion of the rivet portion 22 (the shape of the surface or the caulking gap) and in surface condition.

The laser output of the second laser machining apparatus used in the welding step S12 is kept low, and thereby preventing the influences on the members disposed around the welding points 31.

In the welding step S12, the second laser machining apparatus applying the YAG laser beam sprays an oxygen gas as an assist gas, and the laser welding is performed under oxygen atmosphere.

Hence, the radical oxidation occurs when the member is melted, which leads exothermic reaction, thereby accelerating the laser penetration.

Due to the above feature, the welding step S12 provides improved weldability.

When creating the laser marks 32 are formed in the roughening step S11, the surface and the inside of the grooves of the laser marks 32 are covered with minute dusts.

As described above, the welding step S12 is performed under oxygen atmosphere, and thus the minute dusts remained on the laser marks 32 burn (a dust explosion occurs), the burning in the laser welding is activated, thereby accelerating the welding. As a result, in the welding points 31, the laser penetration and welding areas are obtained sufficiently.

The rivet portion 22 of the negative electrode lead 21 that is the one member to be welded in the laser welding step S1 is the member of high laser reflectivity and the minute portion which is deformed in caulking. So, the conventional method of laser welding cannot be applied to the welding in the case that the member to be welded has high reflectivity on the surface thereof and unstable surface condition due to the caulking and is formed as the minute portion.

On the other hand, the laser welding step S1 includes a first welding step for roughening the surface in the roughening step S11 and a second welding step for welding the surface roughened in the roughening step S11 in the welding step S12, and thereby providing the welding that cannot be provided by the conventional welding method. Moreover, the laser welding step of the embodiment is preferably applicable to the manufacturing process for the battery 10 containing the negative electrode terminal 20 and the negative electrode lead 21 both of which include the above-mentioned welding spots.

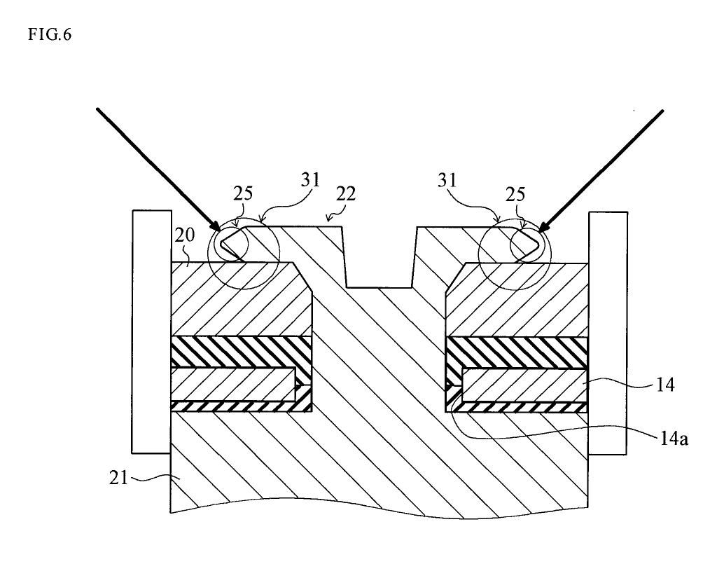

As depicted in FIG. 6, the rivet portion 22 is formed with the edge portion 25 that is a thin portion involved in the welding points 31, and in the welding step S12, the laser beam is preferably applied to the edge portion with 30° to 45° inclined from the inside to the outside.

Thus, when laser welding, the edge portion 25 absorbs the laser beam efficiently, so that the laser output can be decreased and the welding stability is improved.

In the roughening step S11, the laser marks 32 are formed in square and each area thereof is larger than the welding point 31, but the configuration of the laser mark is not limited to this embodiment. For instance, the area of the laser mark 32 may be smaller than that of the welding point 31, and in this case the laser marks 32 is sufficiently melted and welded, and there is enough heat input in the vicinity of the laser marks due to the heat conduction.

The embodiment is applied to the laser welding for the negative side of the battery 10, the lithium ion secondary battery, and may be used in the welding for the member of high laser reflectance on the surface thereof in the same way. For instance, the laser welding step S1 is applicable to the bonding of copper wires broadly installed in electric devices, in this case, the laser welding step substitutes for the soldering.

### INDUSTRIAL APPLICABILITY

The present invention is applicable to a laser welding process in which a laser beam is applied to a rough surface, especially to a technique of laser welding a member of high laser reflectance on the surface thereof.

1. A method of laser welding a first member and a second member comprising:
roughening a surface of the welding portions of the first and second members using a laser beam applied from a first laser machining apparatus; and
melting the roughened surface using laser beam applied from a second laser machining apparatus, and welding the first and second members.

2. The method according to claim 1,
wherein the first and second members are members of high laser reflectance on the surfaces thereof with respect to the laser beam applied from the second laser machining apparatus.

3. The method according to claim 1 or 2,
wherein the welding using the second laser machining apparatus is performed under oxygen atmosphere.

4. A method of manufacturing a battery including the first and second members as a configuration, comprising:
the method of laser welding according to any one of claims 1 to 3.

5. The method according to claim 4,
wherein the first and second members include a portion formed by caulking a rivet portion in the welding portion.
